(19) United States
(12) Patent Application Publication
(10) Pub. No.: US 2020/0108837 A1
(43) Pub. Date: Apr. 9, 2020

(54) DEVICE, METHOD, AND SYSTEM FOR CONTROLING ROAD CURVATURE OF VEHICLE

(71) Applicant: MANDO CORPORATION, Pyeongtaek-si (KR)

(72) Inventors: Tak Gen KIM, Seongnam-si (KR); Jae Suk KIM, Yongin-si (KR)

(21) Appl. No.: 16/595,817

(22) Filed: Oct. 8, 2019

(30) Foreign Application Priority Data
Oct. 8, 2018 (KR) 10-2018-0120080

(51) Int. Cl. B60W 40/072; B60W 30/18; B60W 10/20; G06K 9/00

(52) U.S. Cl. CPC B60W 40/072; B60W 30/18; B60W 10/20; G06K 9/00798; B60W 2550/146; B60R 11/04; B60W 2420/42; B60W 2520/14; B60W 2520/10; B60W 2710/20; B60W 2550/10

(57) ABSTRACT

Disclosed is a vehicle road curvature control device and a method therefor, which correct the road curvature of a vehicle before a yaw rate value is stabilized, when the vehicle enters or leaves a curved road. The present disclosure provides a vision system for a vehicle, which includes: an image sensor disposed at the vehicle so as to have a field of view exterior of the vehicle, the image sensor configured to capture image data; and a controller comprising at least one processor configured to process the image data captured by the image sensor, wherein the controller is configured to: identify a plurality of objects present in the field of view, responsive at least in part to processing of the image data; identify a yaw rate value of the vehicle; calculate a road curvature of an object in front of the vehicle and a road curvature of an object behind the vehicle, based on the plurality of objects; determine a driving state of the vehicle based on the road curvatures of the objects in front of and behind the vehicle or the yaw rate value of the vehicle; and use the road curvature of the object in front of the vehicle as the road curvature of the vehicle until the yaw rate value is stabilized when the driving state of the vehicle is in the state of entering a curved road or in the state of leaving a curved road.

### CROSS REFERENCE TO RELATED APPLICATION

This application claims priority from Korean Patent Application No. 10-2018-0120080, filed on Oct. 8, 2018, which is hereby incorporated by reference for all purposes as if fully set forth herein.

### BACKGROUND OF THE INVENTION

### 1. Field of the Invention

The present disclosure relates to a vehicle road curvature control device and a method therefor and, more particularly, to a vehicle road curvature control device and a method therefor, which correct the road curvature of a vehicle before the yaw rate value is stabilized when the vehicle enters or leaves a curved road.

### 2. Description of the Prior Art

As vehicles have become the necessity in modern life, technologies for improving the safety and the convenience of a driver are highly demanded. Accordingly, a driving assist system (DAS) technology has been continuously studied and developed.

As one of the DAS technologies, there may be a system that assists a driver driving a vehicle. Recently, being developed is an autonomous driving system which recognizes road condition information around a vehicle and drives the vehicle without intervention of a driver. Here, the road condition information around the vehicle may be sensed by a sensor installed in the front side or the back side of the vehicle, or installed in the left and right of the front side or in the left and right of the back side. Based on the sensed road condition information around the vehicle, the vehicle may keep the lane, prevent a collision, and perform driving control such as driving control on a curved road or the like.

When the vehicle drives on a curved road, the vehicle may calculate the road curvature of the vehicle (also referred as ‘vehicle road curvature’) using a yaw rate value sensed via a yaw rate sensor of the vehicle. However, at the point in time at which the vehicle enters or leaves a curved road, there may be a section in which the yaw rate value is unstable due to the reaction speed of the yaw rate sensor of the vehicle. In this instance, the road curvature of the vehicle may have a value different from the actual road curvature, whereby the running stability of the vehicle may be deteriorated.

### SUMMARY OF THE INVENTION

According to the described background, an aspect of the present disclosure is to provide a vehicle road curvature control device and a method therefor, which use a road curvature calculated based on objects around a vehicle as the road curvature of the vehicle until the yaw rate value of the vehicle is stabilized when the vehicle enters or leaves a curved road.

In accordance with an aspect of the present disclosure, there is provided a vision system for a vehicle, which includes: an image sensor disposed at the vehicle so as to have a field of view exterior of the vehicle, the image sensor configured to capture image data; and a controller comprising at least one processor configured to process the image data captured by the image sensor, wherein the controller is configured to: identify a plurality of objects present in the field of view, responsive at least in part to processing of the image data; identify a yaw rate value of the vehicle; calculate a road curvature of an object in front of the vehicle and a road curvature of an object behind the vehicle, based on the plurality of objects; determine a driving state of the vehicle based on the road curvatures of the objects in front of and behind the vehicle or the yaw rate value of the vehicle; and use the road curvature of the object in front of the vehicle as the road curvature of the vehicle until the yaw rate value is stabilized when the driving state of the vehicle is in the state of entering a curved road or in the state of leaving a curved road.

In accordance with another aspect of the present disclosure, there is provided a method of controlling a road curvature of a vehicle, the method including: a vehicle driving information identification operation that identifies a yaw rate value of a vehicle, and detects a plurality of objects existing before and behind the vehicle using an image sensor which is disposed at the vehicle so as to have a field of view exterior the vehicle and is configured to capture image data; a road curvature calculation operation that calculates a road curvature of an object in front of the vehicle and a road curvature of an object behind the vehicle, based on the plurality of objects; a driving state determination operation that compares the road curvature of the object in front of the vehicle and the road curvature of the object behind the vehicle, and determines the driving state of the vehicle based on the road curvatures of the objects in front of and behind the vehicle or the yaw rate value of the vehicle when the road curvature of the object in front of the vehicle and the road curvature of the object behind the vehicle are different from each other; and a road curvature determination operation that uses the road curvature of the object in front of the vehicle as the road curvature of the vehicle until the yaw rate value is stabilized when the driving state of the vehicle is in the state of entering a curved road or in the state of leaving a curved road.

In accordance with another aspect of the present disclosure, there is provided a sensor system, which includes: an image sensor disposed at the vehicle so as to have a field of view exterior of the vehicle, the image sensor configured to capture image data; a non-image sensor selected from a group consisting of a radar sensor and a lidar sensor, and disposed at the vehicle so as to have a field of sensing exterior of the vehicle, the non-image sensor configured to capture sensing data; and a controller comprising at least one processor configured to process the image data captured by the image sensor and the sensing data captured by the non-image sensor, wherein the controller is configured to: identify a plurality of objects present in the field of view, responsive at least in part to processing by the at least one processor of the image data and the sensing data; identify a yaw rate value of a vehicle; calculate a road curvature of an object in front of the vehicle and a road curvature of an object behind the vehicle, based on the plurality of objects; determine a driving state of the vehicle based on the road curvatures of the objects in front of and behind the vehicle or the yaw rate value of the vehicle; and use the road curvature of the object in front of the vehicle as the road curvature of the vehicle until the yaw rate value is stabilized when the driving state of the vehicle is in the state of entering a curved road or in the state of leaving a curved road.

As described above, according to the present disclosure, a vehicle can stably drive on a curved road using the road curvature of an object around the vehicle although the yaw rate value of the vehicle is not stabilized due to the reaction speed of a yaw rate sensor of the vehicle while the vehicle enters or leaves the curved road.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating the configuration of a vehicle road curvature control device according to an embodiment of the present disclosure;

FIG. 2 is a diagram illustrating a sensor installed in a vehicle according to an embodiment of the present disclosure;

FIG. 3 is a diagram illustrating a process of using a road curvature calculated based on objects existing before and behind a vehicle when the vehicle enters a curved road according to an embodiment of the present disclosure;

FIG. 4 is a diagram illustrating the point in time at which the yaw rate value of a vehicle is stabilized when the vehicle enters a curved road according to an embodiment of the present disclosure;

FIG. 5 is a diagram illustrating a process of using a road curvature calculated based on objects existing before and behind a vehicle when the vehicle leaves a curved road according to an embodiment of the present disclosure;

FIG. 6 is a diagram illustrating the point in time at which the yaw rate value of a vehicle is stabilized when the vehicle leaves a curved road according to an embodiment of the present disclosure;

FIG. 7 is a flowchart illustrating a vehicle road curvature control method according to an embodiment of the present disclosure;

FIG. 8 is a flowchart illustrating a method of determining the driving state of a vehicle according to an embodiment of the present disclosure;

FIG. 9 is a flowchart illustrating a method of determining the driving state of a vehicle according to another embodiment of the present disclosure; and

FIG. 10 is a diagram illustrating a vehicle road curvature control system according to an embodiment of the present disclosure.

### DETAILED DESCRIPTION OF THE EXEMPLARY EMBODIMENTS

The present disclosure provides a vehicle road curvature control method and a method therefor.

Hereinafter, embodiments of the present disclosure will be described in detail with reference to the accompanying drawings. In the description of the elements of the present disclosure, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

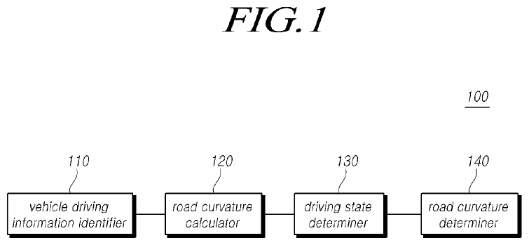

FIG. 1 is a diagram illustrating the configuration of a vehicle road curvature control device according to an embodiment of the present disclosure.

A vehicle road curvature control device of the present disclosure may include: a vehicle driving information identifier that identifies the yaw rate value of a vehicle, and detects a plurality of objects existing before and behind the vehicle using a sensor capable of capturing or sensing an environment around the vehicle; a road curvature calculator that calculates the road curvature of an object in front of the vehicle and the road curvature of an object behind the vehicle, based on the plurality of objects; a driving state determiner that compares the road curvature of the object in front of the vehicle and the road curvature of the object behind the vehicle, and when the road curvature of the object in front of the vehicle and the road curvature of the object behind the vehicle are different from each other, determines the driving state of the vehicle based on the road curvatures of the objects in front of and behind the vehicle or the yaw rate value of the vehicle; and a road curvature determiner that uses the road curvature of the object in front of the vehicle as the road curvature of the vehicle until the yaw rate value is stabilized when the driving state of the vehicle is the state of entering a curved road or the state of leaving a curved road.

In the present disclosure, a vehicle road curvature control device 100 includes a vehicle driving information identifier 110 that identifies the yaw rate value of a vehicle, and detects a plurality of objects existing before and behind the vehicle using a sensor which is installed in the vehicle and is capable of capturing or sensing the environment around the vehicle.

The yaw rate value of the vehicle may be sensed by a yaw rate sensor installed in the vehicle. The yaw rate sensor may be included in the vehicle road curvature control device 100, and the vehicle road curvature control device 100 may identify the yaw rate value of the vehicle which is sensed by the yaw rate sensor. Alternatively, the yaw rate sensor may not be included in the vehicle road curvature control device 100. The vehicle road curvature control device 100 may identify the yaw rate value of the vehicle by receiving the yaw rate value of the vehicle sensed by the yaw rate sensor.

The sensor that is installed in the vehicle and is capable of capturing or sensing the environment around the vehicle, may include at least one of an image sensor and a non-image sensor.

Here, the image sensor may be a vehicle image sensor which is expressed as a camera, an image system, or a vision system. The vehicle image sensor may include a front camera having a view field ahead of the vehicle, a rear camera having a view field behind the vehicle, a rear-lateral camera having a view field corresponding to a lateral side or a rear-lateral side of the vehicle, and the like. In this instance, the vehicle image sensor may selectively include one or more cameras from among the cameras in various directions.

The camera may perform a function of capturing image data around the vehicle and transferring the captured image data to a processor or a controller. The vision system or the image sensor according to an embodiment may further contain an ECU or an image processor that processes captured image data and displays the same on a display, or the like.

Also, the vision system, the image sensor, or the like according to an embodiment may further include an appropriate data link or communication link such as a vehicle network bus or the like for the data transmission or signal communication from the camera to the image processor.

Also, the vehicle to which the present embodiment is applied may further include a non-image sensor such as a radar sensor, a lidar sensor, an ultrasonic sensor, a yaw rate sensor, or the like.

The non-image sensor is disposed in the vehicle, and performs a function of capturing sensing data in order to sense one of objects around the vehicle. Specifically, the non-image sensor transmits electromagnetic waves such as ultrasonic waves or radar waves, receives and analyzes a signal reflected from an object, and calculates information such as the distance to the object, the position of the object, or the like.

The vehicle road curvature control device 100 of the present disclosure detects a plurality of objects existing before and behind the vehicle using a sensor installed in the vehicle. An object may indicate a fixed object existing on a road on which the vehicle currently drives. The fixed object may be an object that has the speed same as the speed of the vehicle from among objects which are detected by the vehicle around the vehicle. For example, the object may indicate a guardrail, a median strip, or a wall existing on the road on which the vehicle drives. Alternatively, the object may indicate a lane on the road on which the vehicle currently drives.

The vehicle road curvature control device 100 according to the present disclosure may include a road curvature calculator 120 that calculates the road curvature of an object in front of the vehicle and the road curvature of an object behind the vehicle, based on the plurality of objects. Herein, the road curvature of the object indicates the curvature of the road where the object is located.

The road curvature calculator 120 of the vehicle road curvature control device 100 according to the present disclosure calculates the road curvature of the object in front of the vehicle based on the object in front of the vehicle which is detected by the vehicle driving information identifier 110, and calculates the road curvature of the object behind the vehicle based on the object behind the vehicle which is detected by the vehicle driving information identifier 110.

The road curvature calculator 120 may sense position information of the objects in front of and behind the vehicle using a sensor that is installed in the vehicle and is capable of capturing or sensing the environment around the vehicle, and may calculate the road curvature of the object in front of the vehicle and the road curvature of the object behind the vehicle based on the sensed position information of the objects. For example, the vehicle may radiate a signal using a sensor such as a radar or lidar, and may receive a signal reflected from objects, thereby sensing the position information of the objects in front of and behind the vehicle. As another example, the vehicle may estimate or extract the distances to objects existing before and behind the vehicle or the position information of the objects using image information associated with a road on which the vehicle drives, which is photographed by a sensor such as a camera. The road curvature calculator 120 may calculate the road curvature of the objects in front of and behind the vehicle based on the position information of the objects in front of and behind the vehicle.

The vehicle road curvature control device 100 according to an embodiment of the present disclosure may detect only an object existing within a predetermined distance range from the position of the vehicle, and may calculate a road curvature based on the object within the corresponding range.

Particularly, the vehicle driving information identifier 110 of the vehicle road curvature control device may additionally identify the position information of the vehicle. The position information of the vehicle may be sensed using a GPS installed in the vehicle. In addition, the vehicle driving information identifier 110 may additionally sense the position information of an object. The vehicle driving information identifier 110 may detect the existence of an object and the position information of the object using a sensor such as a radar or a lidar. Alternatively, the vehicle driving information identifier may estimate or extract distance information or position information of an object from road image information using a sensor such as a camera or the like.

The road curvature calculator 120 of the vehicle road curvature control device may extract an object existing within a predetermined distance from the position of the vehicle, based on information associated with objects detected by the vehicle driving information identifier 110, and may calculate the road curvature of the extracted object. Accordingly, a load of processing the road curvatures of objects around the vehicle may be decreased, and the road curvature of the vehicle may be corrected adaptively as the driving environment changes. Herein, the road curvature of the vehicle or the vehicle road curvature indicates the curvature of the road where the vehicle is located.

The vehicle road curvature control device 100 of the present disclosure may include a driving state determiner 130 that determines the driving state of the vehicle based on the road curvatures of objects in front of and behind the vehicle or the yaw rate value of the vehicle.

The driving state determiner 130 of the vehicle road curvature control device compares the road curvature of the object in front of the vehicle and the road curvature of the object behind the vehicle, and when the road curvatures of the objects in front of and behind the vehicle are the same, determines that the vehicle drives on a predetermined straight road or on a predetermined curved road, and maintains the current driving state.

The driving state determiner 130 of the vehicle road curvature control device compares the road curvature of the object in front of the vehicle and the road curvature of the object behind the vehicle, and when the road curvatures of the objects in front of and behind the vehicle are different from each other, determines that the vehicle is in the state of entering or leaving a curved road.

When the road curvature of the object in front of the vehicle is greater than the road curvature of the object behind the vehicle or when the yaw rate value of the vehicle at a predetermined time section ahead is less than or equal to a predetermined first threshold value, the driving state determiner 130 of the vehicle road curvature control device according to an embodiment of the present disclosure determines the driving state of the vehicle as the state of entering a curved road.

When the road curvature of the object in front of the vehicle is greater than or equal to 0 and the road curvature of the object behind the vehicle is 0, the driving state determiner 130 may determine that the road in front of the vehicle is a curved road and the road behind the vehicle is a straight road, and may determine that the vehicle is in the state of entering a curved road in front of the vehicle from the straight road in the rear.

Alternatively, when the driving state determiner 130 determines that the yaw rate value of the vehicle at a predetermined time section ahead is less than or equal to the predetermined first threshold value, it may be estimated that the vehicle drives on a straight road at a predetermined time section ahead. Therefore, the driving state determiner 130 may determine that the vehicle is in the state of entering a curved road.

When it is determined that the vehicle is in the state of entering the curved road, a vehicle driving system may drive the vehicle adaptively according to the environment of the driving road, such as decreasing the driving speed of the vehicle, correcting the road curvature of the vehicle, or the like.

When the road curvature of the object behind the vehicle is greater than the road curvature of the object in front of the vehicle or when the yaw rate value of the vehicle at a predetermined time section ahead exceeds the predetermined first threshold value, the driving state determiner 130 of the vehicle road curvature control device according to an embodiment of the present disclosure determines the driving state of the vehicle as the state of leaving a curved road.

When the road curvature of the object in front of the vehicle is 0 and the road curvature of the object behind the vehicle is greater than or equal to 0, the driving state determiner 130 may determine that the road in front of the vehicle is a straight road and the road behind the vehicle is a curved road, and may determine that the vehicle is in the state of leaving for the straight road in front of the vehicle from a curved road in the rear.

Alternatively, when the driving state determiner 130 determines that the yaw rate value of the vehicle at a predetermined time section ahead exceeds the predetermined first threshold value, it may be estimated that the vehicle drives on a curved road at a predetermined time section ahead. Therefore, the driving state determiner 130 may determine that the vehicle is in the state of leaving a curved road.

When it is determined that the vehicle is in the state of leaving the curved road, the vehicle driving system may drive the vehicle adaptively according to the environment of the driving road, such as accelerating the driving speed of the vehicle, correcting the road curvature of the vehicle, or the like.

The driving state determiner 130 of the vehicle road curvature control device according to an embodiment of the present disclosure may calculate similarity between the road curvature of the object in front of the vehicle and the road curvature of the object behind the vehicle, may determine that the driving state of the vehicle needs to be changed when the similarity is less than or equal to a predetermined third threshold value, and may determine the driving state of the vehicle based on the road curvatures of the objects in front of and behind the vehicle or the yaw rate value of the vehicle. Therefore, a malfunction of the driving state determination that may occur when the driving road of the vehicle is not totally straight may be prevented.

The vehicle road curvature control device 100 of the present disclosure may include a road curvature determiner 140 that uses the road curvature of an object in front of the vehicle as the road curvature of the vehicle until a yaw rate value is stabilized when the driving state of the vehicle is the state of entering a curved road or the state of leaving a curved road.

In an embodiment of the present disclosure, the point in time at which the yaw rate value is stabilized may indicate the point in time at which a yaw rate variation of the vehicle per hour is less than or equal to a predetermined second threshold value. The fact that the yaw rate variation per hour is less than or equal to the predetermined second threshold value may indicate that the yaw rate sensor of the vehicle senses a yaw rate value corresponding to the driving state of the vehicle. Therefore, the vehicle road curvature control device may obtain the road curvature of the vehicle using the yaw rate value sensed by the yaw rate sensor of the vehicle. Conversely, when the yaw rate variation of the vehicle per hour is greater than the predetermined second threshold value, the driving state of the vehicle changes and the yaw rate value is not stabilized as the yaw rate value corresponding to the driving state of the vehicle, whereby the road curvature of the vehicle may be estimated using the road curvature of an object around the vehicle. When the yaw rate variation of the vehicle per hour is less than or equal to the predetermined second threshold value, the vehicle road curvature control device of the present disclosure may use the road curvature of the object in front of the vehicle as the road curvature of the vehicle.

According to another embodiment of the present disclosure, the vehicle road curvature control device may determine whether a yaw rate value is stabilized based on the driving speed and the yaw rate value of the vehicle. The vehicle driving information identifier may additionally identify the driving speed of the vehicle. The vehicle may calculate the driving road curvature of the vehicle using the driving speed and the yaw rate value of the vehicle. When the yaw rate sensor of the vehicle senses a yaw rate value corresponding to the driving state of the vehicle, the driving road curvature of the vehicle calculated based on the sensed yaw rate value and the driving speed of the vehicle may be identical to the road curvature calculated based on the objects around the vehicle. Therefore, the point in time at which the yaw rate value is stabilized may be the point in time at which the driving road curvature of the vehicle calculated based on the yaw rate value and the driving speed of the vehicle is identical to the road curvature of the object in front of the vehicle.

When the vehicle enters or leaves a curved road, the yaw rate value of the vehicle may be unstable during a predetermined period of time due to the reaction speed of the yaw rate sensor. When the vehicle is in the state of entering or leaving a curved road, the vehicle road curvature control device 100 of the present disclosure may increase the running stability using the calculated road curvature of the object in front of the vehicle as the road curvature of the vehicle until the yaw rate value is stabilized.

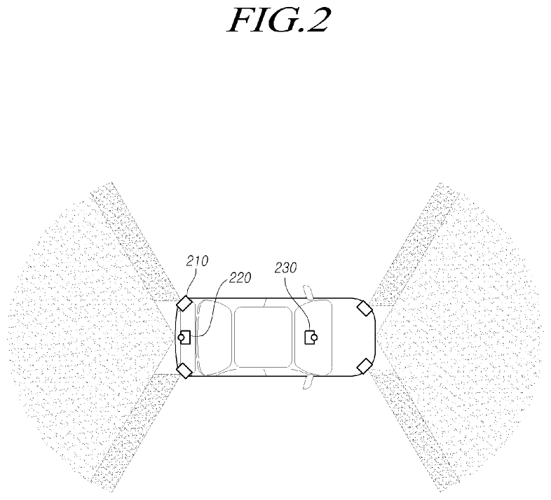

FIG. 2 is a diagram illustrating a sensor installed in a vehicle according to an embodiment of the present disclosure.

The vehicle may include a sensor in the front side or back side of the vehicle, or in the left of the front side or the right of the front side, or in the left of the back side or the right of the back side. In addition, the sensor may be installed in a part where the windscreen of the vehicle exists. The sensor may be installed in any part of the vehicle that allows the sensor to sense the ambient environment information of the vehicle. The sensor installed in the vehicle may be an image sensor, for example, a camera, or may be a non-image sensor, for example, a radar sensor, a lidar sensor, and an ultrasonic sensor. However, the sensor may not be limited thereto.

As illustrated in FIG. 2, a sensor 210 may be installed in the left of the front side of the vehicle or the right of the front side, or may be installed in the left of the back side or the right of the back side. The sensor 210 may be a radar sensor, a lidar sensor, or an ultrasonic sensor. Also, a sensor 220 may be installed in the back side of the vehicle. The sensor 220 may be a camera. Also, a sensor 230 may be installed in the front side or in a part where the windscreen exists. The sensor 230 may be a camera.

The radar sensor or a radar system of the non-image sensor used in the present disclosure may include at least one radar sensor unit. For example, one or more sensor units may be included from among a front sensing radar sensor installed in the front side of the vehicle, a rear radar sensor installed in the back side of the vehicle, and a lateral or rear-lateral sensing radar sensor installed in each lateral side of the vehicle. The radar sensor or the radar system analyzes a transmitted signal and a received signal, performs data processing, and detects information associated with an object. To this end, the radar sensor or radar system may include an electronic or control unit (ECU) or a processor. Data transmission or signal communication from a radar sensor to an ECU may use a communication link such as a suitable vehicle network bus or the like.

The radar sensor may include one or more transmission antennas for transmitting a radar signal, and one or more reception antennas for receiving a signal reflected from an object.

The radar sensor according to an embodiment may adopt a signal transmission/reception scheme of the multiple input multiple output (MIMO) and a multidimensional antenna array in order to form a virtual antenna aperture greater than a real antenna aperture.

For example, two-dimensional antenna array may be used to obtain horizontal and vertical angular accuracy and resolution. When the two-dimensional radar antenna array is used, signals are transmitted and received via separate (time-multiplexing) scanning two times, horizontally and vertically, and MIMO may be used separately from two-dimensional radar horizontal and vertical scanning (time-multiplexing).

More particularly, the radar sensor according to the present embodiment may adopt a two-dimensional antenna array configuration including a transmission antenna unit that includes a total of 12 transmission antennas (Tx) and a reception antenna unit that includes a total of 16 reception antennas (Rx). Therefore, a total of 192 virtual reception antennas are arranged.

In this instance, the transmission antenna unit includes three transmission antenna groups including four transmission antennas. A first transmission antenna group is vertically spaced a predetermined distance from a second transmission antenna group. The first or the second transmission antenna group is horizontally spaced a predetermined distance (D) from a third transmission antenna group.

Also, the reception antenna unit may include four reception antenna groups including four reception antennas. Each reception antenna group is disposed to be vertically spaced apart. The reception antenna unit may be disposed between the first transmission antenna group and the third transmission antenna group which are disposed to be horizontally spaced apart.

Also, according to another embodiment, the antennas of the radar sensor may be disposed in a two-dimensional antenna array. As an example, antenna patches are disposed in a rhombus grid and unnecessary side lobes may be reduced.

Alternatively, the two-dimensional antenna array may include a V-shape antenna array in which a plurality of radiation patches are disposed in the V-shape. More particularly, two V-shape antenna arrays may be included. In this instance, single feed may be performed to the apex of each V-shape antenna array.

Alternatively, the two-dimensional antenna array may include an X-shape antenna array in which a plurality of radiation patches are disposed in the X-shape. More particularly, two X-shape antenna arrays may be included. In this instance, single feed may be performed to the center of each X-shape antenna array.

Also, the radar sensor according to an embodiment may use a MIMO antenna system in order to implement vertical and horizontal sensing accuracy or resolution.

More particularly, in the MIMO system, each transmission antenna transmits a signal having an independent waveform which is distinguished from others. That is, each transmission antenna transmits a signal having an independent waveform which is distinguished from those of other transmission antennas, and each reception antenna may determine a transmission antenna that transmits a signal which is reflected from an object based on the distinguished waveforms of the signals.

Also, the radar sensor according to an embodiment may include a radar housing that accommodates a circuit and a substrate including transmission/reception antennas, and a radome that forms the exterior of the radar housing. In this instance, the radome is formed of materials which may reduce the attenuation of a transmitted and received radar signal. The radome may include the front and rear bumpers of the vehicle, a grille, a side car body, or the external surface of an element of the vehicle.

That is, the radome of the radar sensor may be disposed inside the grille, the bumper, the body of the vehicle, and the like. The radome is disposed in a part of an element that forms the external surface of the vehicle, such as a part of the grille, the bumper, and the body of the vehicle, whereby the vehicle may be esthetically improved and the radar sensor may be conveniently installed.

The lidar of the non-image sensor used in the present disclosure may include a laser transmitter, a receiver, and a processor. The lidar may be implemented based on a time of flight (TOF) scheme or a phase-shift scheme.

The lidar based on the TOF scheme radiates a laser pulse signal, and may receive a reflection pulse signal reflected from an object. The lidar may measure the distance to the object based on a time taken from the radiation of the laser pulse signal to the reception of the reflection pulse signal. Also, the relative speed to the object may be measured based on a change in the distance over time.

The lidar based on the phase-shift scheme may measure a time and the distance to an object based on a phase variation of a signal that returns by being reflected from the object, after the lidar radiates a laser beam continuously modulated with a predetermined frequency. Also, the relative speed to the object may be measured based on a change in the distance over time.

The lidar may detect an object based on a transmitted laser, and may detect the distance to the detected object and the relative speed. When the object is a stationary object (e.g., a street tree, a streetlight, a traffic light, traffic sign, or the like), the lidar may detect the driving speed of a vehicle based on a time of flight (TOF) associated with the object.

The ultrasonic sensor of the non-image sensor used in the present disclosure may include an ultrasonic transmitter, a receiver, and a processor.

The ultrasonic sensor may detect an object based on a transmitted ultrasonic wave, and may detect the distance to the detected object and the relative speed. When the object is a stationary object (e.g., a street tree, a streetlight, a traffic light, traffic sign, or the like), the ultrasonic sensor may detect the driving speed of the vehicle based on a time of flight (TOF) associated with the object.

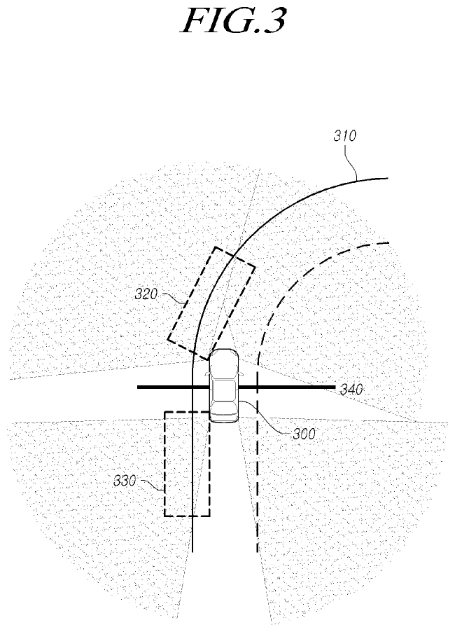

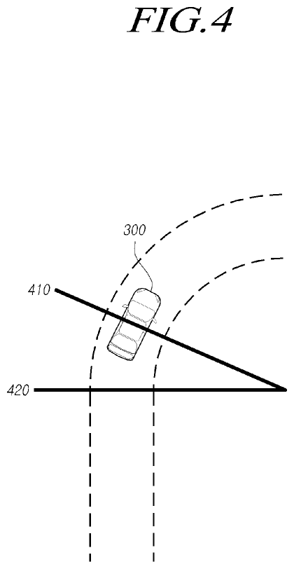

FIGS. 3 and 4 are diagrams illustrating a process of detecting objects existing before and behind a vehicle when the vehicle enters a curved road, and using the road curvature of the object in front of the vehicle as the road curvature of the vehicle until the yaw rate value of the vehicle is stabilized, according to an embodiment of the present disclosure.

A vehicle road curvature control device identifies a yaw rate value, and detects an object 310 existing before and behind a vehicle 300 using a sensor that is installed in the vehicle 300 and is capable of capturing or sensing the ambient environment of the vehicle 300. Here, the detected object may be a fixed object such as a guardrail, a median strip, or a wall, or may be lane information extracted from image information. The vehicle road curvature control device may detect only the object 310 existing on the left of the vehicle 300, or may detect only an object existing on the right of the vehicle 300, or may detect all objects existing on the left and right of the vehicle 300. FIG. 3 provides descriptions from the perspective of the object 310 existing on the left of the vehicle 300. The vehicle road curvature control device identifies the position information of the vehicle 300, and may extract only objects 320 and 330 existing within a predetermined range from the position information of the vehicle 300.

The vehicle road curvature control device may calculate the road curvature of the object in front of the vehicle and the road curvature of the object behind the vehicle, based on the detected objects. When a road curvature is calculated based on objects existing within a predetermined distance from the position of the vehicle 300, the vehicle road curvature control device may calculate the road curvature of the object in front of the vehicle and the road curvature of the object behind the vehicle based on the position information of the objects 320 and 330 of FIG. 3.

The vehicle road curvature control device may compare the calculated road curvatures of the objects in front of and behind the vehicle. When the comparison result shows that the road curvatures of the objects in front of and behind the vehicle are the same, the vehicle 300 may maintain the current driving state. Conversely, when the comparison result shows that the road curvatures of the objects in front of and behind the vehicle are different from each other, it is regarded that the driving state of the vehicle corresponds to one of the state of entering a curved road or the state of leaving a curved road. In FIG. 3, the vehicle 300 is located at the entrance 340 of a curved road, the road curvature of the object in front of the vehicle is greater than 0 and the road curvature of the object behind the vehicle is 0. Therefore, the vehicle road curvature control device may determine that the driving state of the vehicle is the state of entering a curved road. Alternatively, in FIG. 3, the vehicle 300 drives on the straight road before arriving at the entrance 340 of the curved road, and thus, the yaw rate value of the vehicle 300 at a predetermined period of time ahead is 0, which is less than or equal to a predetermined first threshold value. Therefore, the vehicle road curvature control device may determine that the driving state of the vehicle is the state of entering a curved road.

When the driving state of the vehicle is the state of entering a curved road, the road curvature of the object 320 before the vehicle may be used as the road curvature of the vehicle 300 until the yaw rate value is stabilized. Subsequently, at a point 410 in time at which the yaw rate value of the vehicle 300 is stabilized, the vehicle 300 drives based on a road curvature calculated based on the yaw rate value and the driving speed of the vehicle 300. In other words, the road curvature of the object in front of the vehicle may be used as the road curvature of the vehicle during a period of time from an entrance 420 of a curved road of FIG. 4 to the point 410 in time at which the yaw rate value of the vehicle is stabilized.

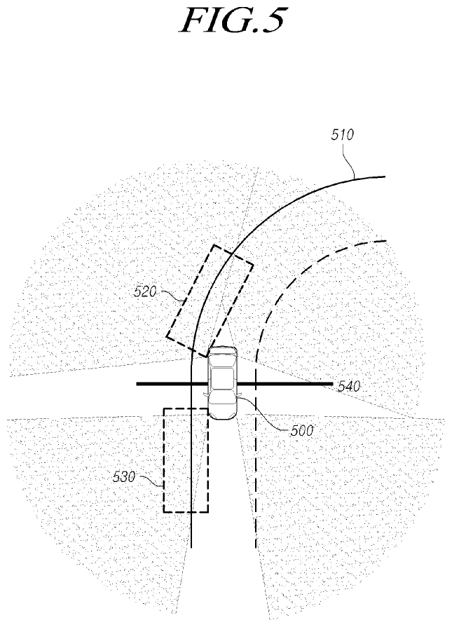

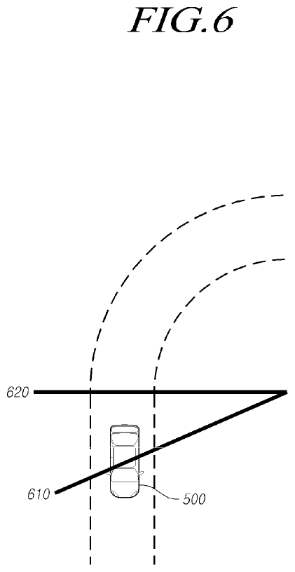

FIGS. 5 and 6 are diagrams illustrating a process of detecting objects existing before and behind a vehicle when the vehicle leaves a curved road, and using the road curvature of the object in front of the vehicle as the road curvature of the vehicle until the yaw rate value of the vehicle is stabilized, according to an embodiment of the present disclosure. FIGS. 3 and 4 are diagrams illustrating the state of entering a curved road. FIGS. 5 and 6 are diagrams illustrating the state of leaving a curved road. Accordingly, only the direction in which the vehicle drives is different and the descriptions associated with detection of an object, comparison of road curvatures, and determination of a road curvature to be used may correspond to the descriptions of FIGS. 3 and 4.

An object that a vehicle 500 of FIG. 5 detects may be an object 510 existing on the right of the vehicle 500, objects 520 and 530 existing within a predetermined range from the position of the vehicle 500 are detected, and a road curvature may be calculated based on the objects. In FIG. 5, the road curvature of the object in front of the vehicle 500 is 0, and the road curvature of the object behind the vehicle 500 is greater than or equal to 0, and thus, the vehicle road curvature control device determines that the driving state of the vehicle is the state of leaving a curved road. Alternatively, the vehicle road curvature control device identifies that the yaw rate value of the vehicle 500 at a predetermined period time ahead is greater than or equal to the predetermined first threshold value, and determines that the vehicle is in the state of leaving a curved road. The road curvature of the object in front of the vehicle is used as the road curvature of the vehicle during a period of time from a point 620 in time at which the vehicle leaves a curved road to a point 610 in time at which the yaw rate value of the vehicle is stabilized.

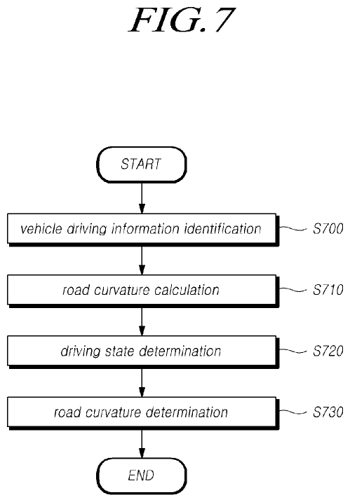

FIG. 7 is a flowchart illustrating a vehicle road curvature control method according to an embodiment of the present disclosure.

The vehicle road curvature control method of the present disclosure may include: a vehicle driving information identification operation that identifies the yaw rate value of a vehicle, and detects a plurality of objects existing before and behind the vehicle using a sensor installed in the vehicle and capable of capturing or sensing the ambient environment of the vehicle; a road curvature calculation operation that calculates the road curvature of an object in front of the vehicle and the road curvature of an object behind the vehicle, based on the plurality of objects; a driving state determination operation that compares the road curvature of the object in front of the vehicle and the road curvature of the object behind the vehicle, and when the road curvature of the object in front of the vehicle and the road curvature of the object behind the vehicle are different from each other, determines the driving state of the vehicle based on the road curvatures of the objects in front of and behind the vehicle or the yaw rate value of the vehicle; and a road curvature determination operation that uses the road curvature of the object in front of the vehicle as the road curvature of the vehicle until the yaw rate value is stabilized when the driving state of the vehicle is the state of entering a curved road or the state of leaving a curved road.

In the present disclosure, the vehicle road curvature control method includes vehicle driving information identification operation S700 that identifies the yaw rate value of a vehicle, and detects a plurality of objects existing before and behind the vehicle using a sensor which is installed in the vehicle and is capable of capturing or sensing the environment around the vehicle.

The yaw rate value of the vehicle may be sensed by a yaw rate sensor installed in the vehicle. The yaw rate sensor may be included in a vehicle road curvature control device, and the vehicle road curvature control device may identify the yaw rate value of the vehicle which is sensed by the yaw rate sensor. Alternatively, the yaw rate sensor may not be included in the vehicle road curvature control device. The vehicle road curvature control device may identify the yaw rate value of the vehicle by receiving the yaw rate value of the vehicle sensed by the yaw rate sensor.

The vehicle road curvature control device of the present disclosure detects a plurality of objects existing before and behind the vehicle using a sensor installed in the vehicle. An object may indicate a fixed object existing on a road on which the vehicle currently drives. The fixed object may be an object that has the speed same as the speed of the vehicle, from among objects which are detected by the vehicle. For example, the object may indicate a guardrail, a median strip, or a wall existing on the road on which the vehicle drives. Alternatively, the object may indicate a lane on the road on which the vehicle currently drives.

The vehicle road curvature control method of the present disclosure may include road curvature calculation operation that calculates the road curvature of an object in front of the vehicle and the road curvature of an object behind the vehicle, based on the plurality of objects in operation S710.

The vehicle road curvature control device according to an embodiment of the present disclosure may detect only an object existing within a predetermined distance range from the position of the vehicle, and may calculate a road curvature based on the object within the corresponding range.

Particularly, the vehicle road curvature control device may additionally identify the position information of the vehicle. The position information of the vehicle may be sensed using a GPS installed in the vehicle. In addition, the vehicle road curvature control device may additionally sense the position information of an object. The vehicle road curvature control device may detect the existence of an object and the position information of the object using a sensor such as a radar or a lidar. Alternatively, the vehicle road curvature control device may estimate or extract distance information of an object from road image information using a sensor such as a camera or the like.

The vehicle road curvature control device may extract an object existing within a predetermined distance from the position of the vehicle, based on the detected information associated with the object, and may calculate the road curvature of the extracted object. Accordingly, a load of processing the road curvature of an object around the vehicle may be decreased, and the road curvature of the vehicle may be corrected adaptively as a driving condition changes.

The vehicle road curvature control method of the present disclosure may include driving state determination operation S720 that compares the road curvature of the object in front of the vehicle and the road curvature of the object behind the vehicle, and when the road curvatures of the objects in front of and behind the vehicle are different from each other, may determine the driving state of the vehicle based on the road curvatures of the objects in front of and behind the vehicle or the yaw rate value of the vehicle.

The vehicle road curvature control device compares the road curvature of the object in front of the vehicle and the road curvature of the object behind the vehicle, and when the road curvatures of the objects in front of and behind the vehicle are the same, determines that the vehicle drives on a predetermined straight road or on a predetermined curved road, and maintains the current driving state.

The vehicle road curvature control device compares the road curvature of the object in front of the vehicle and the road curvature of the object behind the vehicle, and when the road curvatures of the objects in front of and behind the vehicle are different from each other, determines that the vehicle is in the state of entering or leaving a curved road.

When the road curvature of the object in front of the vehicle is greater than the road curvature of the object behind the vehicle or when the yaw rate value of the vehicle at a predetermined time section ahead is less than or equal to a predetermined first threshold value, the vehicle road curvature control device according to an embodiment of the present disclosure determines that the driving state of the vehicle is the state of entering a curved road.

When the road curvature of the object in front of the vehicle is greater than or equal to 0 and the road curvature of the object behind the vehicle is 0, the vehicle road curvature control device may determine that the road in front of the vehicle is a curved road and the road behind the vehicle is a straight road, and may determine that the vehicle is in the state of entering a curved road in front of the vehicle from the straight road in the rear.

Alternatively, when the yaw rate value of the vehicle at a predetermined time section ahead is less than or equal to the predetermined first threshold value, and it is estimated that the vehicle drives on a straight road at the predetermined time section ahead, the vehicle road curvature control device may determine that the vehicle is in the state of entering a curved road.

When the road curvature of the object behind the vehicle is greater than the road curvature of the object in front of the vehicle or when the yaw rate value of the vehicle at a predetermined time section ahead exceeds the predetermined first threshold value, the vehicle road curvature control device according to an embodiment of the present disclosure determines that the driving state of the vehicle is the state of leaving a curved road.

When the road curvature of the object in front of the vehicle is 0 and the road curvature of the object behind the vehicle is greater than or equal to 0, the vehicle road curvature control device may determine that the road in front of the vehicle is a straight road and the road behind the vehicle is a curved road, and may determine that the vehicle is in the state of leaving a curved road by driving from the curved road in the rear to the straight road in front of the vehicle.

Alternatively, when the yaw rate value of the vehicle at a predetermined time section ahead exceeds the predetermined first threshold value, and it is estimated that the vehicle drives on a curved road at the predetermined time section ahead, the vehicle road curvature control device may determine that the vehicle is in the state of leaving the curved road.

The vehicle road curvature control device according to an embodiment of the present disclosure may calculate similarity between the road curvature of the object in front of the vehicle and the road curvature of the object behind the vehicle, and when the similarity is less than or equal to a predetermined third threshold value, may determine the driving state of the vehicle based on the road curvatures of the objects in front of and behind the vehicle and the yaw rate value of the vehicle. Therefore, a malfunction in the driving state determination that may occur when the driving road of the vehicle is not totally straight may be prevented.

The vehicle road curvature control method of the present disclosure may include road curvature determination operation S730 that uses the road curvature of the object in front of the vehicle as the road curvature of the vehicle until a yaw rate value is stabilized when the driving state of the vehicle is the state of entering a curved road or the state of leaving a curved road.

In an embodiment of the present disclosure, the point in time at which the yaw rate value is stabilized may indicate the point in time at which a yaw rate variation of the vehicle per hour is less than or equal to a predetermined second threshold value. The fact that the yaw rate variation per hour is less than or equal to the predetermined second threshold value may indicate that the yaw rate sensor of the vehicle senses a yaw rate value corresponding to the driving state of the vehicle. Therefore, the vehicle road curvature control device may obtain the road curvature of the vehicle using the yaw rate value sensed by the yaw rate sensor of the vehicle. Conversely, the fact that the yaw rate variation of the vehicle per hour is greater than the predetermined second threshold value may indicate that the yaw rate value of the vehicle is not stabilized. Accordingly, the road curvature of the vehicle may be estimated using the road curvature of an object around the vehicle. When the yaw rate variation of the vehicle per hour is less than or equal to the predetermined second threshold value, the vehicle road curvature control device of the present disclosure may use the road curvature of the object in front of the vehicle as the road curvature of the vehicle.

According to another embodiment of the present disclosure, the vehicle road curvature control device may determine whether a yaw rate value is stabilized based on the driving speed and the yaw rate value of the vehicle. The vehicle road curvature control device may additionally identify the driving speed of the vehicle. The vehicle may calculate the driving road curvature of the vehicle using the driving speed and the yaw rate value of the vehicle. When the yaw rate sensor of the vehicle senses a yaw rate value corresponding to the driving state of the vehicle, the driving road curvature of the vehicle calculated based on the sensed yaw rate value and the driving speed of the vehicle may be identical to the road curvature calculated based on an object around the vehicle. Therefore, the point in time at which the yaw rate value is stabilized may be the point in time at which the driving road curvature of the vehicle calculated based on the yaw rate value and the driving speed of the vehicle is identical to the road curvature of the object in front of the vehicle.

The yaw rate value of the vehicle when the vehicle enters or leaves a curved road may be unstable during a predetermined period of time due to the reaction speed of the yaw rate sensor. When the vehicle is in the state of entering or leaving a curved road, the vehicle road curvature control device of the present disclosure may increase the running stability using the calculated road curvature of the object in front of the vehicle as the road curvature of the vehicle until the yaw rate value is stabilized.

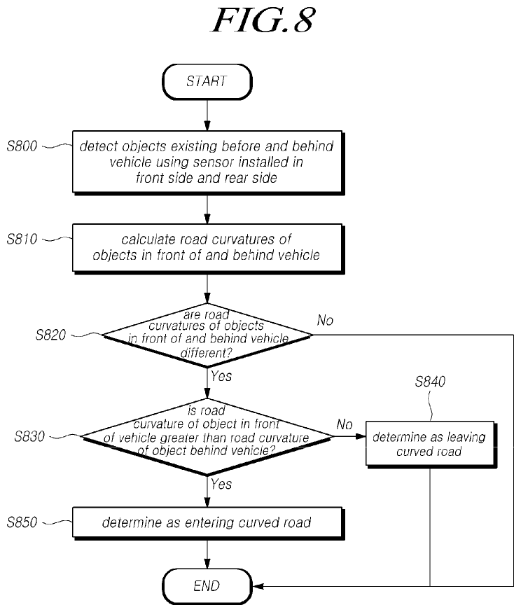

FIG. 8 is a flowchart illustrating a method of determining the driving state of a vehicle according to an embodiment of the present disclosure.

A vehicle road curvature control device detects objects existing around a vehicle using a sensor that is installed in the vehicle and is capable of capturing and sensing the ambient environment of the vehicle in operation S800. The vehicle road curvature control device may detect only objects existing within a predetermined distance from the position of the vehicle. The vehicle road curvature control device may calculate the road curvature of an object in front of the vehicle and the road curvature of an object behind the vehicle, based on the detected objects in operation S810. The vehicle road curvature control device compares the calculated road curvature of the object in front of the vehicle and the calculated road curvature of the object behind the vehicle, and determines whether they are different from each other in operation S820. When the road curvatures of the objects in front of and behind the vehicle are the same, the vehicle road curvature control device determines that the driving state of the vehicle is not changed, and maintains the current driving state. When the road curvatures of the objects in front of and behind the vehicle are different from each other, the vehicle road curvature control device compares the magnitude of the road curvatures of the objects in front of and behind the vehicle in operation S830. When the road curvature of the object in front of the vehicle is greater than the road curvature of the object behind the vehicle, the vehicle road curvature control device determines that the vehicle is in the state of entering a curved road in operation S850. When the road curvature of the object behind the vehicle is greater than the road curvature of the object in front of the vehicle, the vehicle road curvature control device determines that the vehicle is in the state of leaving a curved road in operation S840.

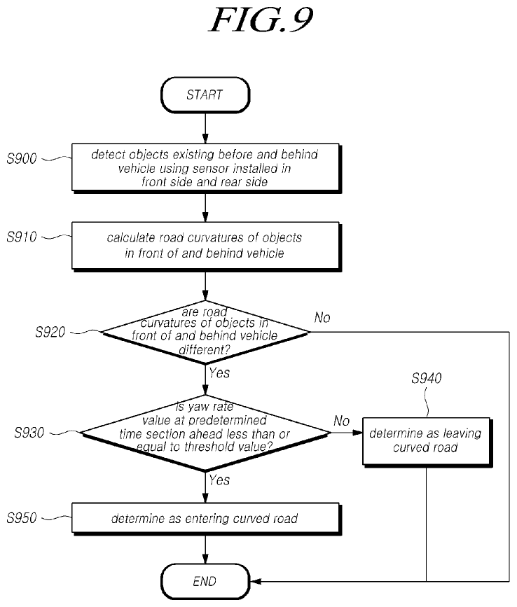

FIG. 9 is a flowchart illustrating a method of determining the driving state of a vehicle according to another embodiment of the present disclosure. Except for operation S830 in the flowchart of FIG. 8, the operations in FIG. 9 correspond to the operations in FIG. 8. Therefore, descriptions for the operation S900 to S920, S940, and S950 of FIG. 9 will be omitted. When the road curvatures of the objects in front of and behind the vehicle are different from each other, the vehicle road curvature control device determines whether the yaw rate value of the vehicle at a predetermined time section ahead is less than or equal to a threshold value in operation S930 of FIG. 9. When the yaw rate value of the vehicle at the predetermined time section ahead is less than or equal to the threshold value, it is determined that the vehicle is in the state of entering a curved road in operation S950. When the yaw rate value of the vehicle at the predetermined time section ahead is not less than or equal to the threshold value, it is determined that the vehicle is in the state of leaving a curved road in operation S940.

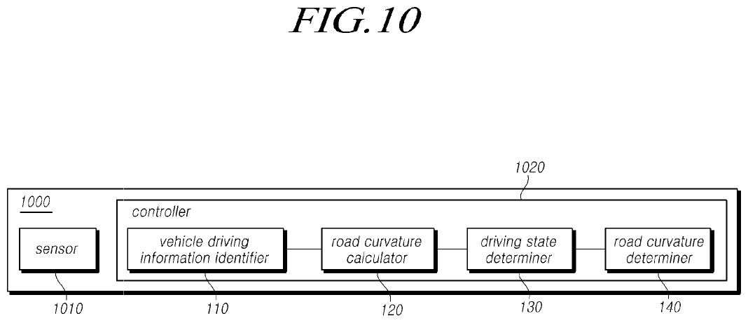

FIG. 10 is a diagram illustrating a vehicle road curvature control system according to an embodiment of the present disclosure. A vehicle road curvature control system according to the present disclosure may include a sensor 110 that is installed in a vehicle and is capable of capturing or sensing the ambient environment of the vehicle, and a controller 1020 that identifies the yaw rate value of the vehicle, detects one or more objects existing around the vehicle using data captured or sensed by the sensor 1010, calculates the road curvature of an object in front of the vehicle and the road curvature of an object behind the vehicle based on the detected objects, compares the road curvatures thereof, determines the driving state of the vehicle based on the road curvatures or the yaw rate value of the vehicle when the road curvature of the object in front of the vehicle and the road curvature of the object behind the vehicle are different from each other, and uses the road curvature of the object in front of the vehicle as the road curvature of the vehicle until the yaw rate value is stabilized when the vehicle is in the state of entering a curved road or in the state of leaving a curved road.

The sensor 1010 according to the present embodiment may include at least one of an image sensor and a non-image sensor. The detailed descriptions of the image sensor and the non-image sensor can be understood with reference to the descriptions of the image sensor and the non-image sensor which have been provided in FIGS. 1 and 2. Therefore, the detailed descriptions thereof will be omitted.

The controller 1020 may perform the functions of each element of the vehicle road curvature control device which have been described in FIG. 1, particularly, the vehicle driving information identifier 110, the road curvature calculator 120, the driving state determiner 130, and the road curvature determiner 140.

Also, the controller 1020 according to the present embodiment may function as a controller that integrates the vehicle driving information identifier 110, the road curvature calculator 120, the driving state determiner 130, and the road curvature determiner 140.

The controller 1020 according to the present embodiment may include at least one processor for processing data captured or sensed by the sensor 1010. The controller is configured to receive a result of processing the captured image data from the processor, to receive captured sensing data from a plurality of non-image sensors, and to process at least one of the image data and the sensing data.

The controller identifies the yaw rate value of the vehicle based at least partially on the processing of image data captured by the image sensor, detects one or more objects existing around the vehicle, calculates the road curvature of an object in front of the vehicle and the road curvature of an object behind the vehicle based on the detected objects, compares the road curvatures thereof, determines the driving state of the vehicle based on the road curvatures thereof or the yaw rate value of the vehicle when the road curvature of the object in front of the vehicle and the road curvature of the object behind the vehicle are different from each other, and uses the road curvature of the object in front of the vehicle as the road curvature of the vehicle until the yaw rate value is stabilized when the vehicle is in the state of entering a curved road or in the state of leaving a curved road.

Also, the controller or the integrated controller according to the present embodiment may be configured as a domain control unit (DCU) that integrates a function of receiving and processing information of various vehicle sensors, a function of relaying transmission and reception of a sensor signal, a function of detecting driving information and ambient object information of the vehicle according to the present embodiment, calculating a road curvature based on the detected information, and using the road curvature as the road curvature of the vehicle under a certain condition, and the like. However, the controller or the integrated controller may not be limited thereto.

The integrated controller (DCU) may process one or more pieces of data from among image data captured by an image sensor and sensing data captured by a non-image sensor, identifies the yaw rate value of the vehicle based at least partially on the processing of the image data captured by the image sensor and the processing of sensing data captured by the non-image sensor, detects a plurality of objects existing before and behind the vehicle using at least one of the image data captured by the image sensor and the sensing data captured by the non-image sensor, calculates the road curvature of an object in front of the vehicle and the road curvature of an object behind the vehicle based on the plurality of objects, determines the driving state of the vehicle based on the road curvatures of the objects in front of and behind the vehicle or the yaw rate value of the vehicle, and uses the road curvature of the object in front of the vehicle as the road curvature of the vehicle until the yaw rate value is stabilized when the driving state of the vehicle is in the state of entering a curved road or in the state of leaving a curved road.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

The above description and the accompanying drawings provide an example of the technical idea of the present disclosure for illustrative purposes only. Those having ordinary knowledge in the technical field, to which the present disclosure pertains, will appreciate that various modifications and changes in form, such as combination, separation, substitution, and change of a configuration, are possible without departing from the essential features of the present disclosure. Therefore, the embodiments disclosed in the present disclosure are intended to illustrate the scope of the technical idea of the present disclosure, and the scope of the present disclosure is not limited by the embodiment. That is, at least two elements of all structural elements may be selectively joined and operate without departing from the scope of the present disclosure. The scope of the present disclosure shall be construed on the basis of the accompanying claims in such a manner that all of the technical ideas included within the scope equivalent to the claims belong to the present disclosure.

What is claimed is:

1. A vision system for a vehicle, the vision system comprising:
an image sensor disposed at the vehicle so as to have a field of view exterior of the vehicle, the image sensor configured to capture image data; and
a controller comprising at least one processor configured to process the image data captured by the image sensor,
wherein the controller is configured to:
identify a plurality of objects present in the field of view, responsive at least in part to processing of the image data;
identify a yaw rate value of the vehicle;
calculate a road curvature of an object in front of the vehicle and a road curvature of an object behind the vehicle, based on the plurality of objects;
determine a driving state of the vehicle based on the road curvatures of the objects in front of and behind the vehicle or the yaw rate value of the vehicle; and
use the road curvature of the object in front of the vehicle as the road curvature of the vehicle until the yaw rate value is stabilized when the driving state of the vehicle is in the state of entering a curved road or in the state of leaving a curved road.

2. The vision system of claim 1, wherein the controller is further configured to identify position information of the vehicle, detect position information of the plurality of objects, and calculate the road curvature of the object in front of the vehicle and the road curvature of the object behind the vehicle based on position information of an object existing within a predetermined distance from the position of the vehicle.

3. The vision system of claim 1, wherein the controller is further configured to determine that the driving state of the vehicle is in the state of entering a curved road when the road curvature of the object in front of the vehicle is greater than the road curvature of the object behind the vehicle or when the yaw rate value of the vehicle at a predetermined time section ahead is less than or equal to a predetermined first threshold value.

4. The vision system of claim 1, wherein the controller is further configured to determine the driving state of the vehicle is in the state of leaving a curved road when the road curvature of the object behind the vehicle is greater than the road curvature of the object in front of the vehicle or when the yaw rate value of the vehicle at a predetermined time section ahead exceeds a predetermined first threshold value.

5. The vision system of claim 1, wherein a point in time at which the yaw rate value is stabilized indicates a point in time at which a yaw rate variation of the vehicle per hour is less than or equal to a predetermined second threshold value.

6. The vision system of claim 1, wherein the controller is further configured to identify a driving speed of the vehicle, and
a point in time at which the yaw rate value is stabilized indicates a point in time at which a driving road curvature of the vehicle calculated based on the driving speed and the yaw rate value of the vehicle is identical to the road curvature of the object in front of the vehicle.

7. A method of controlling a road curvature of a vehicle, the method comprising:
a vehicle driving information identification operation that identifies a yaw rate value of a vehicle, and detects a plurality of objects existing before and behind the vehicle using an image sensor which is disposed at the vehicle so as to have a field of view exterior the vehicle and is configured to capture image data;
a road curvature calculation operation that calculates a road curvature of an object in front of the vehicle and a road curvature of an object behind the vehicle, based on the plurality of objects;
a driving state determination operation that determines a driving state of the vehicle based on the road curvatures of the objects in front of and behind the vehicle or the yaw rate value of the vehicle; and
a road curvature determination operation that uses the road curvature of the object in front of the vehicle as the road curvature of the vehicle until the yaw rate value is stabilized when the driving state of the vehicle is in the state of entering a curved road or in the state of leaving a curved road.

8. The method of claim 7, wherein the vehicle driving information identification operation additionally identifies position information of the vehicle and detects position information of the plurality of objects, and
the road curvature calculation operation calculates the road curvature of the object in front of the vehicle and the road curvature of the object behind the vehicle based on position information of an object existing within a predetermined distance from the position of the vehicle.

9. The method of claim 7, wherein the driving state determination operation determines the driving state of the vehicle is in the state of entering a curved road when the road curvature of the object in front of the vehicle is greater than the road curvature of the object behind the vehicle or when the yaw rate value of the vehicle at a predetermined time section ahead is less than or equal to a predetermined first threshold value.

10. The method of claim 7, wherein the driving state determination operation determines that the driving state of the vehicle is in the state of leaving a curved road when the road curvature of the object behind the vehicle is greater than the road curvature of the object in front of the vehicle or when the yaw rate value of the vehicle at a predetermined time section ahead exceeds a predetermined first threshold value.

11. The method of claim 7, wherein a point in time at which the yaw rate value is stabilized indicates a point in time at which a yaw rate variation of the vehicle per hour is less than or equal to a predetermined second threshold value.

12. The method of claim 7, wherein the vehicle driving information identification operation additionally identifies a driving speed of the vehicle, and
the point in time at which the yaw rate value is stabilized indicates a point in time at which a driving road curvature of the vehicle calculated based on the yaw rate value of the vehicle and the driving speed is identical to the road curvature of the object in front of the vehicle.

13. A sensor system for a vehicle, the sensor system comprising:
an image sensor disposed at the vehicle so as to have a field of view exterior of the vehicle, the image sensor configured to capture image data;
a non-image sensor selected from a group consisting of a radar sensor and a lidar sensor, and disposed at the vehicle so as to have a field of sensing exterior of the vehicle, the non-image sensor configured to capture sensing data; and
a controller comprising at least one processor configured to process the image data captured by the image sensor and the sensing data captured by the non-image sensor,
wherein the controller is configured to:
identify a plurality of objects present in the field of view, responsive at least in part to processing by the at least one processor of the image data and the sensing data;
identify a yaw rate value of a vehicle;
calculate a road curvature of an object in front of the vehicle and a road curvature of an object behind the vehicle, based on the plurality of objects;
determine a driving state of the vehicle based on the road curvatures of the objects in front of and behind the vehicle or the yaw rate value of the vehicle; and
use the road curvature of the object in front of the vehicle as the road curvature of the vehicle until the yaw rate value is stabilized when the driving state of the vehicle is in the state of entering a curved road or in the state of leaving a curved road.

14. The sensor system of claim 13, wherein the controller is further configured to identify position information of the vehicle, detect position information of the plurality of objects, and calculate the road curvature of the object in front of the vehicle and the road curvature of the object behind the vehicle based on position information of an object existing within a predetermined distance from the position of the vehicle.

15. The sensor system of claim 13, wherein the controller is further configured to determine that the driving state of the vehicle is in the state of entering a curved road when the road curvature of the object in front of the vehicle is greater than the road curvature of the object behind the vehicle or when the yaw rate value of the vehicle at a predetermined time section ahead is less than or equal to a predetermined first threshold value.

16. The sensor system of claim 13, wherein the controller is further configured to determine the driving state of the vehicle is in the state of leaving a curved road when the road curvature of the object behind the vehicle is greater than the road curvature of the object in front of the vehicle or when the yaw rate value of the vehicle at a predetermined time section ahead exceeds a predetermined first threshold value.

17. The sensor system of claim 13, wherein a point in time at which the yaw rate value is stabilized indicates a point in time at which a yaw rate variation of the vehicle per hour is less than or equal to a predetermined second threshold value.

18. The sensor system of claim 13, wherein the controller is further configured to identify a driving speed of the vehicle, and
a point in time at which the yaw rate value is stabilized indicates a point in time at which a driving road curvature of the vehicle calculated based on the driving speed and the yaw rate value of the vehicle is identical to the road curvature of the object in front of the vehicle.
